(19) United States
(12) Patent Application Publication
(10) Pub. No.: US 2026/0320890 A1
(43) Pub. Date: Oct. 15, 2026

(54) TEXT-TO-ANIMATION GENERATION

(71) Applicant: Snap Inc., Santa Monica, CA (US)

(72) Inventors: Bing Zhou, Rye, NY (US); Chuan Guo, Jersey City, NJ (US); Jian Wang, West New York, NJ (US)

(21) Appl. No.: 19/179,910

(22) Filed: Apr. 15, 2025

(51) Int. Cl. G06T 13/40; G06F 40/30; G06F 40/40; G06N 3/0455; G06T 19/00

(52) U.S. Cl. CPC G06T 13/40; G06F 40/30; G06F 40/40; G06N 3/0455; G06T 19/006

(57) ABSTRACT

Examples relate to systems and methods for generating an animation from a text prompt. The systems and methods receive a text prompt describing a desired animation and expand the text prompt using a large language model (LLM) to generate a detailed motion description that includes specific movements of different skeletal joints. The systems and methods generate, using a diffusion-based transformer model conditioned on the detailed motion description, a latent vector representation of a motion sequence. The systems and methods decode the latent vector representation into animation data and apply post-processing to the animation data to reduce motion artifacts and generate a final animation sequence compatible with a three-dimensional avatar.

### TECHNICAL FIELD

The present disclosure relates to computer graphics technologies, specifically to generative rendering engines for generating animations on user devices.

### BACKGROUND

Some electronics-enabled devices, such as computers and mobile devices, allow users to generate personalized video content based on text prompts and reference images. Current approaches to video generation have evolved significantly with the advent of diffusion models, which have demonstrated impressive capabilities in generating realistic videos from text descriptions. These models typically operate by learning to denoise randomly generated noise into coherent visual content guided by textual descriptions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates an animation generation system, according to some examples.

FIG. 6 is a flowchart illustrating a routine (e.g., a method or process), according to some examples.

FIG. 7 is a flowchart illustrating a routine (e.g., a method or process), according to some examples.

FIG. 8 illustrates a system including the head-wearable apparatus, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Animation generation, particularly for 3D avatars and human motion sequences, has traditionally been a complex and resource-intensive process. In conventional animation pipelines, artists create animations for 3D avatars such as Bitmojis or other character models through a multi-stage workflow that involves sketching, storytelling, modeling, and finally animation. These animations enhance app engagement by boosting visual appeal, offering feedback, guiding users, increasing interactivity, and enabling storytelling. However, the traditional methods for creating these animations involve significant manual effort and technical expertise. This process is remarkably inefficient, often requiring several days of work to produce merely 10 seconds of animation. The result is a slow, expensive process that limits the scalability and accessibility of animation creation.

Furthermore, conventional text-to-motion models suffer from significant limitations due to their training data. Existing motion capture datasets typically contain only high-level, sparse annotations (such as “a person is dancing”) rather than detailed descriptions of movement. This sparsity in annotation prevents models from understanding the nuances of human motion, such as specific limb movements, body posture, and temporal sequences. As a result, these models struggle with generalization, performing poorly when presented with prompts that were not explicitly covered in their training data. Additionally, many existing systems rely on Contrastive Language-Image Pre-training (CLIP) embeddings. CLIP is a text embedding model trained with image pairs that outputs a single vector without temporal information because it was designed for generating images. This limitation makes them ill-suited for capturing the sequential nature of animations, particularly when dealing with complex action sequences.

The disclosed examples address these technical problems and improve the efficiency of using the electronic device by providing a system that generates high-fidelity human motion animations from textual input, such as in seconds rather than days, significantly reducing the time and manual effort required in traditional animation pipelines. The disclosed system leverages motion capture data, dense text annotations, large language models (LLMs), and a customized text-to-animation model to automate the creation of detailed animations that can be directly applied to 3D avatars. This can eliminate the need for manual keyframing and animation polishing by skilled professionals. Further, the system can address technical limitations, such as by reducing artifacts like foot skating and body interpenetration, by incorporating advanced techniques such as LLM-based prompt expansion, diffusion-based transformer models, and specialized post-processing steps to enhance the quality and realism of the generated content while minimizing computational resources. The system not only streamlines the animation production workflow but also makes animation creation more accessible and scalable across various applications including social media, augmented reality, virtual reality, film, storytelling, and video games.

Specifically, the disclosed techniques receive a text prompt describing a desired animation and expand the text prompt using a LLM to generate a detailed motion description that includes specific movements of different skeletal joints. The disclosed techniques generate, using a diffusion-based transformer model conditioned on the detailed motion description, a latent vector representation of a motion sequence. The disclosed techniques decode the latent vector representation into animation data and apply post-processing to the animation data to reduce motion artifacts and generate a final animation sequence compatible with a three-dimensional avatar.

The disclosed system achieves significant technical improvements in computational efficiency through its innovative architecture and processing methodology. By implementing a variational autoencoder (VAE) that compresses motion data along the temporal axis, such as by a factor of 4, the disclosed system can reduce the dimensionality of the motion representation from Lx148 to (L/4)xD_latent, where D_latent=256, enabling more efficient processing of complex motion sequences. The diffusion-based transformer model with cross-attention mechanisms optimizes the conditioning of motion generation on text embeddings, while a T5 text encoder produces temporally-aware vector sequences that capture sequential motion semantics more effectively than single-vector representations. Furthermore, the disclosed system's multi-loss training approach, which incorporates flow velocity loss, feature loss, joint position loss, foot skating loss, and smoothness loss, creates a more robust latent space representation that reduces computational redundancy during inference. The root motion prediction network's specialized architecture for estimating global movements in the XZ plane can eliminate the need for computationally expensive post-processing iterations, while the integrated training of the diffusion model and VAE decoder creates a more coherent latent space that requires fewer sampling steps to achieve high-quality results. This can significantly reduce the computational resources required for animation generation.

### NETWORKED COMPUTING ENVIRONMENT

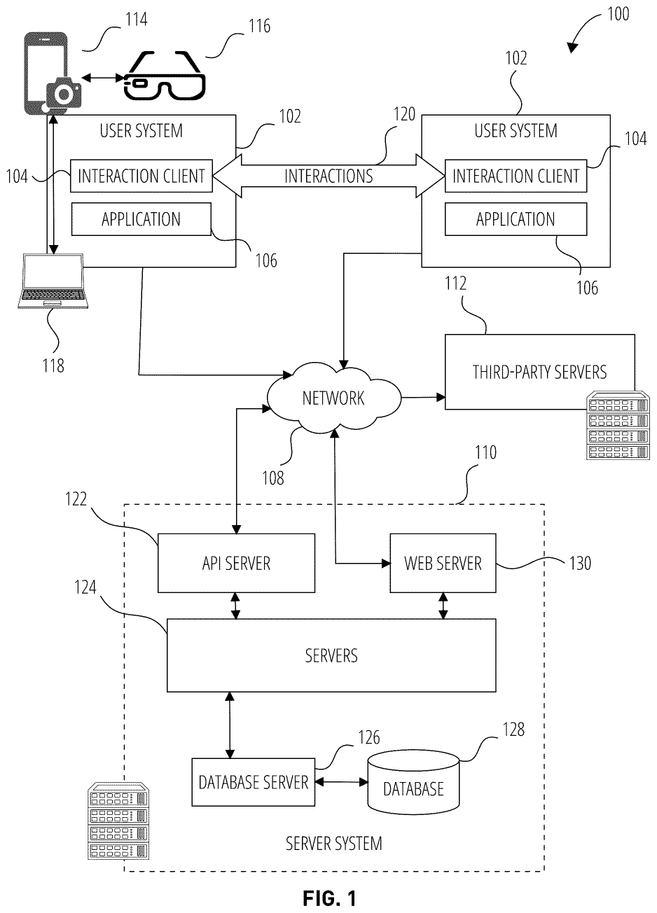

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102, a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to, and provides programmatic interfaces to, servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

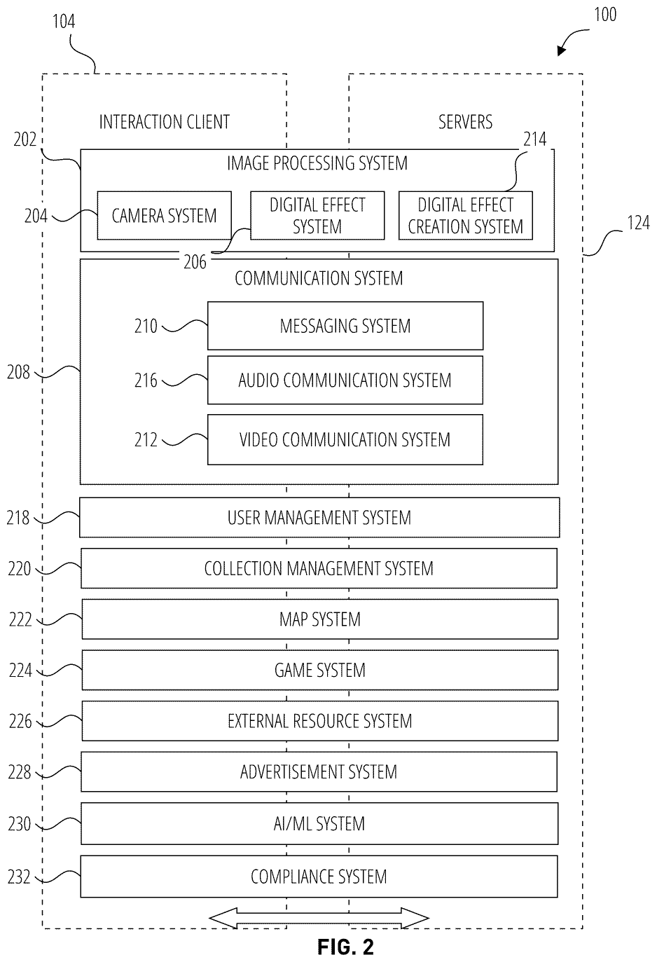

The servers 124 host multiple systems and subsystems, described below with reference to FIG. 2.

### EXTERNAL RESOURCES AND LINKED APPLICATIONS

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative machine learning models to generate the digital effects experiences, such as by presenting artificially generated or artificially augmented video with one or more digital effects.

### SYSTEM ARCHITECTURE

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture.

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 802 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A digital effect(s) application (or digital effects experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up a menu (e.g., animates a menu as surfacing from a bottom of the screen to a middle or other portion of the screen) for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, animations, clothing, and so forth.

An advertisement system 228 operationally enables the purchasing of advertisements by third parties for presentation to end users via the interaction clients 104 and handles the delivery and presentation of these advertisements.

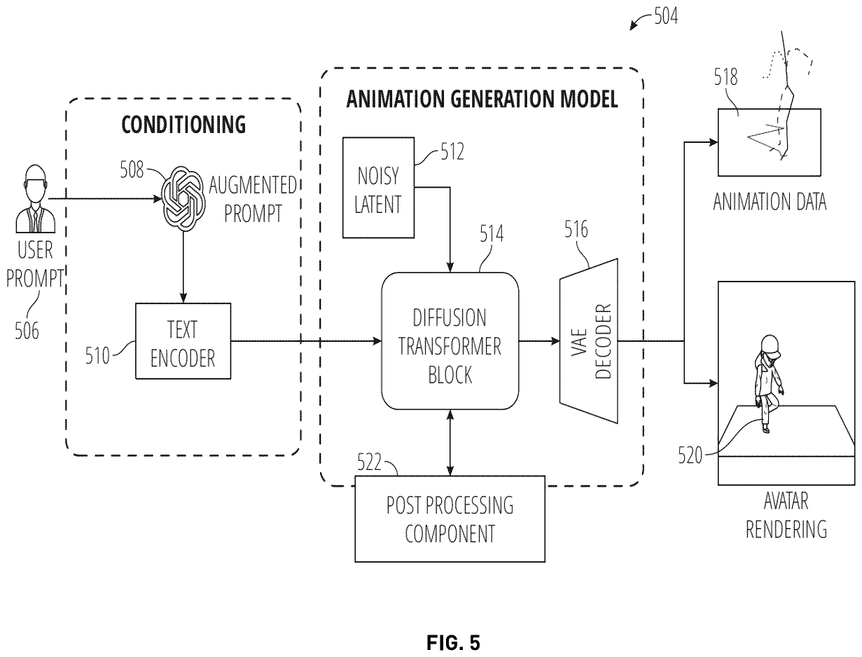

An artificial intelligence and machine learning system 230 provides a variety of services to different subsystems within the digital interaction system 100 including an animation generation system 504 (FIG. 5).

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions.

For example, the artificial intelligence and machine learning system 230 (e.g., using the animation generation system 504) provides comprehensive support for text-to-animation generation through integration with various components. The artificial intelligence and machine learning system 230 operates by receiving text prompts describing desired animations and expanding these prompts using a LLM to generate detailed motion descriptions that include specific movements of different skeletal joints.

When processing the expanded text prompts, the artificial intelligence and machine learning system 230 employs a T5 text encoder to produce an embedding sequence that preserves temporal semantics, unlike conventional approaches that use CLIP, which outputs a single vector without temporal information. This architectural design allows the artificial intelligence and machine learning system 230 to achieve better alignment between text descriptions and motion sequences, resulting in more realistic animation outputs. The artificial intelligence and machine learning system 230 binds detailed motion descriptions with corresponding skeletal movements, allowing users to explicitly specify complex animations through simple text prompts, thereby preventing misalignment issues where models might incorrectly interpret high-level descriptions.

For animation generation tasks, the artificial intelligence and machine learning system 230 implements a diffusion-based transformer model with cross-attention mechanisms that iteratively predicts motion latents from text embeddings, ensuring accurate alignment between text and motion. The artificial intelligence and machine learning system 230 then decodes these latent vector representations into animation data using a VAE decoder that was jointly trained with the diffusion model for better latent space alignment. The artificial intelligence and machine learning system 230 applies sophisticated post-processing techniques to the animation data, including foot inverse kinematics, root motion prediction, and animation retargeting, which help prevent artifacts such as foot skating, floor penetration, and body part interpenetration, enabling the generation of animations with natural motion and pose variations rather than simply reproducing predefined animations.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data, for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained during machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

The neural network architecture implemented for avatar animation may include specialized components like Generative Adversarial Networks (GANs) that can generate realistic facial animations, and Recurrent Neural Networks (RNNs) that can process the temporal aspects of speech. The model learns to generate smooth, natural-looking animations that accurately reflect the timing and characteristics of the input speech. In the prediction phase, when processing new user speech input, the trained model analyzes the audio features and generates corresponding avatar animations in real time. The model can handle various speech modifications, including language translation and emotional style changes, by learning correlations between different speech patterns and appropriate animation responses. This enables the system to generate realistic avatar animations without requiring complex tracking or modeling systems. The training process also incorporates techniques for handling different avatar types and customization options. The model learns to adapt the generated animations to different avatar facial structures while maintaining natural movement patterns. This allows the system to work effectively with avatars that have visual features representing the user or their friends, while ensuring consistent and realistic animation quality.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### DATA ARCHITECTURE

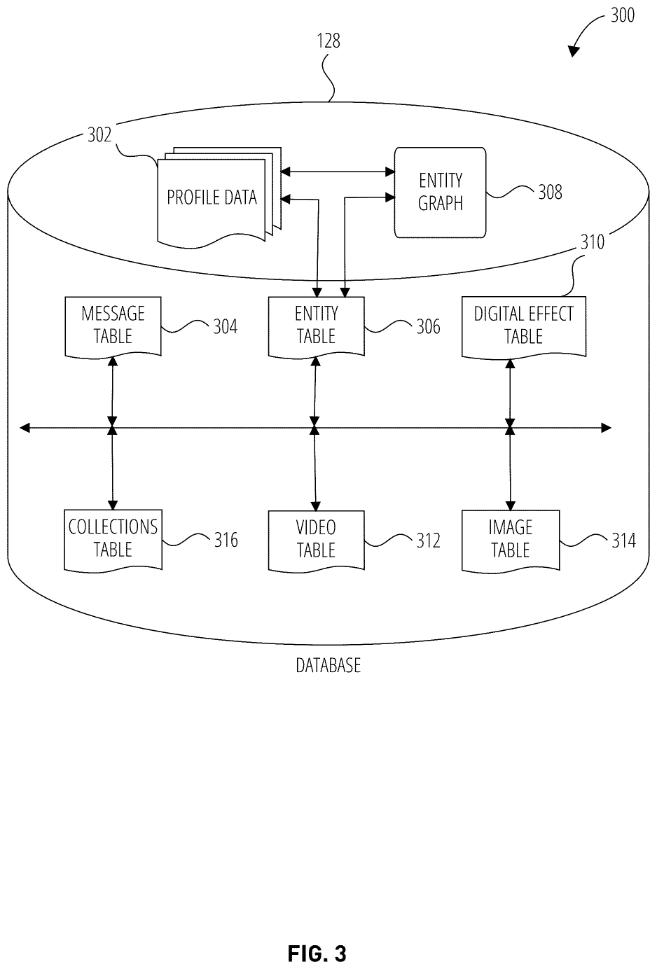

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores animation data, such as motion capture sequences and text annotations, in a digital animation table. The animation data is associated with and applied to 3D avatars (for which data is stored in an avatar table) and motion sequences (for which data is stored in a motion sequence table). For example, the database 128 stores several types of data used for text-to-animation generation by the animation generation system, particularly for training data collection and model operation.

For training data collection, the database 128 stores motion capture data in the motion sequence table, which contains the training sequences used to extract skeletal movements for reference animations and ground truth motions for model training. These motion sequences are used for the supervised learning approach where the diffusion-based transformer model learns to generate animations by comparing its outputs with actual motion capture data. Image data can be stored in the avatar table, including 3D Bitmoji avatars, BodyMorph models, and other character rigs that can be animated using the generated motion data. The database also stores detailed textual descriptions for each motion sequence, capturing nuances such as limb movement, body posture, and facial expressions. Digital animation data can include multiple textual variations of each motion sequence generated by an LLM to enhance model robustness, VAE parameters for compressing human motion sequences into latent vector representations, and sets of post-processing parameters used to reduce motion artifacts such as foot skating and body part interpenetration.

The database 128 also includes an ML model update database that stores associations between tasks, base ML models, and parameter updates. This includes entries that link task identifiers with base ML model identifiers and update identifiers, enabling efficient lookup and retrieval of appropriate model components when users select particular tasks.

Additionally, the database 128 stores entity information in the entity table 306, which maintains records about individuals and other entities appearing in videos, and collections data in the collections table 316, which organizes sets of messages and associated media content. These tables help establish relationships between subjects, objects, and backgrounds in the training data, supporting the binding mechanism that associates reference images with corresponding entity words in text prompts.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

The collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences.

### DATA COMMUNICATIONS ARCHITECTURE

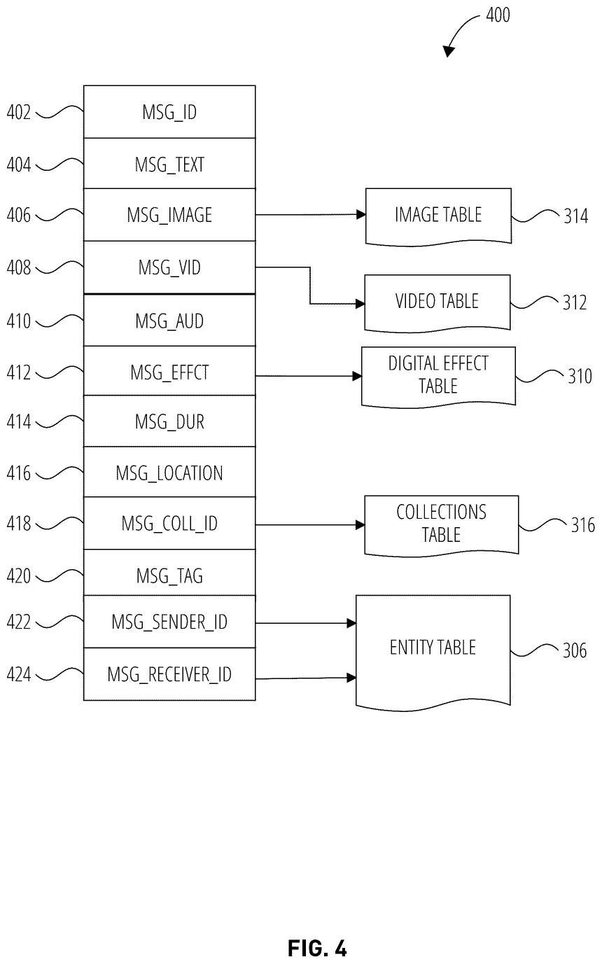

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

### ANIMATION GENERATION SYSTEM

FIG. 5 illustrates an animation generation system 504, according to some examples. Specifically, FIG. 5 depicts a comprehensive end-to-end system for generating animations from text prompts.

Initially, a user prompt 506 can be received as an initial text input provided by a user describing a desired animation. This user prompt 506 serves as the starting point for the animation generation process and can be as simple as “a person is dancing” or “a person is playing golf.”

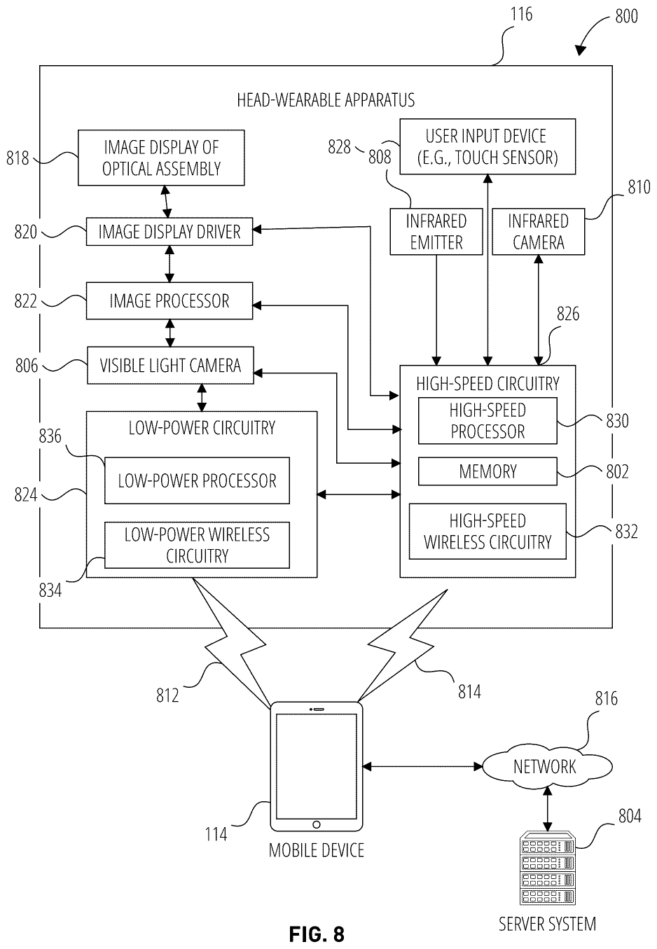

The user prompt 506 can be received through various input methods and in different forms across the digital interaction system 100. The user prompt 506 can be received as a text input directly entered through a keyboard or touch interface on a user system 102, which may include a mobile device 114, a head-wearable apparatus 116, or a computer client device 118 as shown in FIG. 1. The user prompt 506 can also be received as a voice input captured through the audio communication system 216 shown in FIG. 2, where the voice command is automatically converted to text using speech recognition capabilities of the artificial intelligence and machine learning system 230. This allows users to verbally describe desired animations such as “a person is dancing” or “a person is playing golf” without needing to type. Additionally, the user prompt 506 can be received through the messaging system 210 as part of a conversation between users, where a text message containing animation instructions is processed by the system. The prompt can also be received through the user input device 828 (e.g., touch sensor) on the head-wearable apparatus 116 shown in FIG. 8, allowing users to input animation requests through gesture controls or touch interactions.

The user prompt 506 can further be received from third-party applications 106 or third-party servers 112 via the external resource system 226, enabling integration with other software platforms. The prompt may also be generated automatically based on user activity detected by the map system 222 or game system 224, creating contextually relevant animations based on user location or in-game events. Regardless of input method, once received, the user prompt 506 serves as the starting point for the animation generation process and is processed by the LLM 508 to generate the detailed motion description needed for high-quality animation generation.

In some cases, the user prompt 506 is fed into a conditioning section where it is processed by the LLM 508. The LLM 508 expands the typically concise user prompt into an augmented prompt that includes detailed motion descriptions with specific movements of different skeletal joints. This expansion is important for generating high-quality animations as it provides more specific guidance to the animation generation model.

For example, for a simple prompt like “A person is playing golf,” the LLM 508 can expand the prompt to include specific body positioning: “The person prepares to play golf, standing with feet shoulder-width apart. They grip the club firmly, taking a moment to aim. With a smooth backswing, they rotate their torso and then swing forward, striking the ball with precision. They follow through with controlled movement, watching the ball's trajectory before relaxing their stance.” This augmented prompt adds details about foot positioning, grip firmness, torso rotation, and follow-through movements that are not present in the original prompt.

As another example, when the prompt specifies “A person walks like a zombie,” the LLM 508 can generate an augmented prompt, such as “The person walks like a zombie, moving with stiff, jerky steps. Their arms dangle loosely before occasionally lurching forward. Their head tilts to one side, and their shoulders slump as they stagger unevenly, dragging one foot behind. Their upper body sways unnaturally, giving the impression of a lifeless, reanimated creature.” The augmentation adds specific joint movements including arm positioning, head tilt, shoulder posture, and foot dragging patterns. For another prompt specifying “A person is dancing ballet,” the LLM 508 can create an augmented prompt, such as “The person performs a graceful ballet dance, starting with arms extended and a gentle rise to their toes. They spin elegantly in a controlled pirouette, arms flowing smoothly. With a soft leap, they land delicately, bending their knees into a plié, then glide forward with pointed toes in a series of flowing steps.” This adds technical ballet movements, arm positions, toe pointing, and specific knee actions.

In some examples, the LLM 508 also adds emotional context to animations by extracting expression labels. For example, the LLM 508 might augment a prompt with “expression: happy” or “expression: idle” which is later used to apply appropriate facial expressions to the animation, even though the original prompt contained no emotional indicators.

For example, the animation generation system 504 can maintain a comprehensive database of facial expressions organized by emotional categories such as “happy,” “idle,” “sad,” “laugh,” and “mad.” This database contains pre-defined facial animation sequences that can be applied to 3D avatars. When processing a user prompt, the LLM 508 analyzes the text to identify emotional context, even when the original prompt contains no explicit emotional indicators. For example, a prompt like “a person is dancing excitedly” might be augmented with “expression: happy” based on the LLM's understanding of the emotional context implied by “excitedly.” During the animation generation process, the animation generation system 504 searches the facial expression database using the extracted expression label. The animation generation system 504 then retrieves the corresponding facial animation data that matches the identified emotional state. This retrieval process involves accessing the database 128 through the database server 126, where the facial expression data is stored alongside other animation-related information. The retrieved facial expression is then applied to the 3D avatar 520 in conjunction with the body animation data, creating a cohesive animation that conveys both physical movement and appropriate emotional expression. This approach allows the system to generate emotionally appropriate animations even when users fail to explicitly specify the emotional state in their prompts, significantly enhancing the expressiveness and realism of the generated animations.

When processing action sequences, the LLM 508 can break down complex movements into sequential steps. For a prompt like “A person sits down, then stands up and claps,” the LLM 508 can expand each action with specific joint rotations, weight shifts, and hand positions for each phase of the movement sequence. The LLM 508 can infer culturally specific movements from general descriptions. For example, with “A person is dancing Gangnam Style,” the LLM 508 can add the characteristic horse-riding gestures, crossed wrists, and bouncing movements specific to that dance, even though these were not explicitly mentioned in the original prompt.

These expansions enable the system to generate more realistic and detailed animations by providing the diffusion-based transformer model 514 with specific skeletal joint movements that were not present in the original concise user prompts.

The augmented prompt from the LLM 508 is then passed to a text encoder 510. The text encoder 510 converts the detailed textual description (e.g., the augmented prompt) into a numerical representation that preserves temporal semantics. Unlike conventional approaches that use CLIP embeddings (which output single vectors without temporal information), the text encoder 510 produces a sequence of vectors that better capture the sequential nature of animations. This is a significant technical improvement because animations inherently involve sequences of movements over time, which cannot be adequately represented by a single vector.

For example, the text encoder 510 can implement a T5 (Text-to-Text Transfer Transformer) model architecture, which is particularly well-suited for capturing temporal relationships in text. When processing the augmented prompt, the T5-based text encoder 510 outputs a sequence of vectors rather than a single vector, with each vector in the sequence corresponding to different aspects or segments of the described motion. The sequence of vectors produced by the text encoder 510 can have a maximum length of 120 tokens, with each token having a dimension of 4096. This results in a comprehensive embedding dimension of 120×4096, providing sufficient representational capacity to encode complex motion descriptions with their temporal relationships intact. This dimensionality can vary depending on the specific text embedding model used, but the multi-vector sequence structure remains consistent.

The text encoder 510 applies a fixed-length embedding and masks the text encoding for improved motion understanding. This approach allows the system to maintain consistent representation sizes while focusing on the most relevant parts of the text description. The resulting sequence of vectors serves as conditioning input to the diffusion-based transformer model 514, enabling it to generate animations that accurately reflect not just what movements should occur, but also their proper sequence and timing. This temporal awareness in the text embedding is important for generating animations that involve multiple sequential actions (such as “a person sits down, then stands up and claps”), as it allows the animation generation system 504 to properly order and time each component of the complex motion sequence.

The output from the text encoder 510 feeds into the animation generation model (e.g., the diffusion-based transformer model 514). Within this diffusion-based transformer model 514, a noisy latent vector 512 is processed by the diffusion-based transformer model 514. The diffusion-based transformer model 514 can include cross-attention mechanisms to condition the generation process on the text embeddings from the text encoder 510. The diffusion-based transformer model 514 iteratively refines the noisy latent vector 512 to generate a latent vector representation of the desired motion sequence. This process can involve multiple transformer layers, each having multiple attention heads, which work together to interpret the text embeddings and generate corresponding motion patterns.

For example, the diffusion-based transformer model 514 operates on the principle of iterative denoising, where it starts with a completely noisy latent vector 512 and progressively refines it into a coherent motion representation. This denoising process follows a carefully controlled schedule that gradually transforms random noise into structured motion data. The model can employ a depth of 8 transformer layers, with each layer containing 4 attention heads and a latent dimension of 512, resulting in approximately 39 million trainable parameters.

During the generation process, the cross-attention mechanisms within the diffusion-based transformer model 514 align the generated motion with the text description. These mechanisms allow the diffusion-based transformer model 514 to focus on different parts of the text embedding sequence when generating different segments of the motion, ensuring temporal coherence and semantic alignment between the text description and the resulting animation. For example, when processing a prompt like “a person walks forward then raises their arms,” the cross-attention mechanisms ensure that the walking motion is generated before the arm-raising motion, maintaining the correct temporal order specified in the text.

The diffusion-based transformer model 514 implements rectified flow for the diffusion process, which provides more stable and efficient generation compared to traditional diffusion approaches. This technique allows the diffusion-based transformer model 514 to predict velocity vectors that guide the transformation from noise to structured motion data. The model is trained using multiple loss functions, including flow velocity loss, feature loss, joint position loss, foot skating loss, and smoothness loss (e.g., which can be implemented by the post processing component 522), which collectively ensure that the generated latent vectors can be decoded into physically plausible and visually appealing animations. These sophisticated training objectives enable the diffusion-based transformer model 514 to capture the nuances of human motion, such as natural joint rotations, proper weight distribution, and realistic movement trajectories.

In some examples, the diffusion-based transformer model 514 can be trained through a sophisticated process that leverages high-quality motion capture data stored in the database 128. This training data consists of extensive human motion sequences that have been meticulously annotated with detailed textual descriptions (e.g., generated by the LLM 508) capturing nuances of limb movement, body posture, and motion characteristics. Each motion sequence is paired with multiple textual variations generated by the LLM 508 to enhance the model's robustness and ability to understand diverse phrasings of similar movements.

During training, the system first processes the textual descriptions through the text encoder 510 to generate text embeddings that preserve temporal semantics. These embeddings serve as conditioning signals for the diffusion-based transformer model 514. Simultaneously, the system processes the corresponding motion capture data through a VAE to create ground truth latent vector representations. The diffusion process begins with random noise that is gradually transformed into structured motion data through iterative denoising steps guided by the text embeddings.

For each training iteration, the diffusion-based transformer model 514 predicts velocity vectors that guide the transformation from noise to structured motion data. The system then computes multiple types of losses to evaluate the quality of the generated motion. The flow velocity loss measures the accuracy of the predicted velocity vectors compared to ground truth vectors, serving as the primary guidance for the diffusion process. After generating the latent vectors, the system decodes them using the VAE decoder and computes a feature loss by comparing the decoded representations with ground truth motion features, ensuring the latent space accurately captures motion characteristics.

The system further applies forward kinematics to the decoded motion features to obtain joint positions and computes a joint position loss by comparing these with ground truth positions from the original motion capture data. This ensures that the generated animations maintain proper skeletal structure and positioning. Additionally, the system computes specialized losses focused on motion quality, including a foot skating loss that penalizes unrealistic foot movements where feet appear to slide across the ground, and a smoothness loss that ensures natural transitions between poses without jerkiness or unnatural accelerations.

These multiple loss functions are aggregated into a total loss value that guides the parameter updates of the diffusion-based transformer model 514. Using backpropagation, the system adjusts the model's parameters to minimize this total loss, gradually improving the model's ability to generate realistic and physically plausible animations from text descriptions. The training process continues iteratively, with the model parameters being updated based on batches of training examples, until the model achieves sufficient accuracy in generating motion sequences that align with textual descriptions while maintaining natural movement patterns.

The integration of multiple specialized loss functions represents a significant advancement over conventional diffusion models, which typically rely solely on noise prediction losses. By incorporating losses that specifically target motion quality aspects like foot skating and joint positioning, the system ensures that the generated animations not only match the textual descriptions but also exhibit the natural joint rotations, proper weight distribution, and realistic movement trajectories necessary for high-quality character animation.

As an example, a training sample for the text-to-animation generation system can be received involving the motion sequence “playing golf,” which demonstrates how the system processes and learns from annotated motion capture data. For this training sample, the system begins with high-quality motion capture data of a person performing a golf swing, stored in the motion sequence table within the database 128. This motion capture data contains complete skeletal movement information including root translations, joint rotations, and global positioning data captured at 30 frames per second. The training sample is paired with multiple detailed textual descriptions that go far beyond simple labels. Rather than just “playing golf,” the annotation can read: “The person prepares to play golf, standing with feet shoulder-width apart. They grip the club firmly, taking a moment to aim. With a smooth backswing, they rotate their torso and then swing forward, striking the ball with precision. They follow through with controlled movement, watching the ball's trajectory before relaxing their stance.” To enhance robustness, the LLM 508 can generate 5-10 variations of this description with different phrasings but maintaining the same detailed movement information. These variations help the model learn to understand diverse ways users might describe the same motion.

During the training process, the system processes this paired data through multiple stages. First, the textual description is encoded using the T5 text encoder to produce a sequence of vectors, such as 120×4096 dimensional embedding, that preserves temporal semantics. Simultaneously, the motion capture data is processed through the variational autoencoder to create ground truth latent vector representations. The diffusion-based transformer model 514 then learns to predict these latent vectors from the text embeddings by computing multiple specialized losses: flow velocity loss to measure accuracy of predicted velocity vectors, feature loss comparing decoded representations with ground truth motion features, joint position loss ensuring proper skeletal structure, foot skating loss penalizing unrealistic foot movements, and smoothness loss ensuring natural transitions between poses. These multiple loss functions are aggregated into a total loss value that guides parameter updates through backpropagation, gradually improving the model's ability to generate realistic golf swing animations from textual descriptions that match the nuanced movements captured in the original motion data.

The latent vector representation generated by the diffusion-based transformer model 514 is then passed to a VAE component 516, specifically a VAE decoder, which decodes the latent vector representation into animation data 518. The latent vector representation can be processed by the post processing component 522 before being fed to the VAE component 516. In some cases, the post processing component 522 is part of the diffusion-based transformer model 514. In some cases, the post processing component 522 is a separate processing block from the diffusion-based transformer model 514. The VAE decoder within the VAE component 516 transforms the abstract latent representation into concrete motion data. This decoder can be jointly trained with the diffusion-based transformer model 514 to ensure better latent space alignment, resulting in more coherent and realistic animations.

The VAE component 516 can be trained using motion capture data through a process that compresses human motion sequences into latent vector representations and then reconstructs them. The training process involves several key steps. First, the system captures extensive human motion capture data and segments it into short sequences. These motion sequences are input into the VAE encoder, which compresses them into latent vector representations. During training, the VAE component 516 consists of both an encoder and decoder component. The encoder compresses the motion data into latent vectors, while the decoder reconstructs the original motion data from these latent vectors. The system computes a reconstruction loss between the original human motion sequences and the reconstructed ones to evaluate the encoding-decoding accuracy.

The VAE component 516 architecture specifically compresses motion features along the temporal axis. The system then updates the parameters of both the VAE encoder and decoder based on the comparison between the reconstruction loss and a threshold value, with the goal of minimizing this loss and improving compression efficiency. This joint training ensures better latent space alignment between the encoder and decoder components. Once trained, only the decoder portion of the VAE component 516 is used during the animation generation process. The diffusion-based transformer model 514 generates latent vectors directly, which are then decoded by the VAE decoder to produce the final motion data.

The animation data 518 represents the raw motion sequence, including root translations (global positioning) and local rotations of body joints. This data consists of a sequence of skeletal positions and rotations that define how the character (e.g., 3D avatar) should move over time. The raw animation data 518 can be processed by the post processing component 522 (e.g., if not implemented as part of the diffusion-based transformer model 514), which applies various techniques to reduce motion artifacts such as foot skating, floor penetration, and body part interpenetration. This post processing component 522 ensures that the generated animations maintain physical plausibility and visual quality. The post processing component 522 performs several important functions, including applying foot inverse kinematics to correct foot placement issues, which prevents feet from penetrating through the ground or floating above it unnaturally.

Another function of the post processing component 522 is predicting global root movements in the XZ plane to reduce foot skating issues, which is a common artifact in generated animations where feet appear to slide across the ground instead of stepping firmly. For example, the post processing component 522 can include a specialized root motion prediction network that addresses the common foot skating issue in generated animations. First, the root motion prediction network analyzes the local joint rotations and other motion features from the raw animation data to predict appropriate global root movements specifically in the XZ plane (the horizontal ground plane). This is important because foot skating occurs when the global translation of the character fails to properly align with the local foot movements, causing feet to appear to slide across the ground rather than making firm contact.

The network employs a specialized architecture similar to the motion VAE model but with a certain difference. The network is designed to mask out the root XZ velocities in the input features and predict them as output. This targeted approach allows the system to focus specifically on the relationship between local joint movements and appropriate global translation, rather than simply copying global movements from training data.

The root motion prediction network can be trained through a specialized process that focuses specifically on learning the relationship between local joint movements and appropriate global translation. The training data for the root motion prediction network can consist of high-quality motion capture sequences stored in the motion sequence table within the database 128. These sequences contain complete human motion data including both local joint rotations and global root movements. During data preparation, the system processes this motion capture data to create training pairs where the input features consist of all motion data except the root XZ velocities (which are deliberately masked out) and the target output consists of only the root XZ velocities (the ground truth values). This masking approach is important as it forces the network to learn how to infer appropriate global root movements solely from local joint rotations and other motion features, rather than simply copying patterns from the training data.

The training process begins when the system first masks out the root XZ velocities in the input motion features, creating incomplete motion data where only local joint rotations and other parameters are visible to the network. This masked motion data is then processed by the root motion prediction network, which shares a similar architecture to the motion VAE model but is specifically designed to predict the missing root XZ velocities. The network analyzes relationships between foot positions, joint rotations, and the character's center of mass to predict when feet should be planted versus in motion, and what global root movement would maintain physical plausibility. For each training sample, the system computes a deviation (error) between the predicted root XZ velocities generated by the network and the ground truth root XZ velocities from the original motion capture data. This computed deviation is then compared with a threshold value to determine prediction accuracy and guide the parameter updates.

The parameter updating process involves calculating the error between predicted and ground truth root XZ velocities using appropriate loss functions that measure the accuracy of the predicted global movements. The system then compares this error against established thresholds to determine if the current prediction accuracy is sufficient. If the error exceeds the threshold, the system updates the network parameters through backpropagation, adjusting weights to minimize the deviation between predicted and actual root movements. This training process continues iteratively until the network achieves sufficient accuracy in predicting appropriate global root movements that maintain physical plausibility while reducing foot skating artifacts. The resulting trained network can then effectively analyze local joint movements during inference and predict appropriate global root translations that prevent the common foot skating issues in the final animation sequence.

During operation, the root motion prediction network examines the relationship between foot positions and the character's center of mass to determine when feet should be planted firmly on the ground versus when they should be in motion. When a foot is detected as being in a “planted” state (in contact with the ground), the network ensures that the global root movement is adjusted so that the foot remains fixed relative to the ground plane, preventing the sliding effect. The network also accounts for the character's momentum and weight distribution across different poses, ensuring that the predicted global movements maintain physical plausibility. This is particularly important for animations involving complex weight shifts, such as dancing or sports movements, where improper root motion can make the entire animation appear unrealistic.

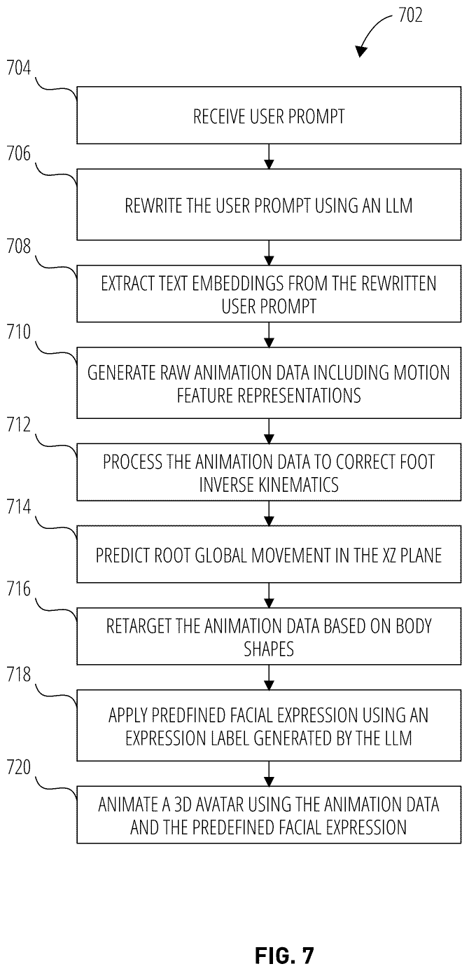

As shown in FIG. 7, operation 714, this root motion prediction step is integrated into the overall animation pipeline after the foot inverse kinematics correction (operation 712) but before animation retargeting (operation 716). This sequential processing ensures that foot placement issues are resolved before global movement is refined, creating a more coherent and physically plausible final animation. The root motion prediction significantly reduces foot skating artifacts while maintaining the intended character of the motion, resulting in animations that appear more grounded and realistic when applied to 3D avatars.

The post processing component 522 can also perform animation retargeting to accommodate different character body proportions and shapes. This ensures that the generated animations can be applied to various 3D avatar models with different skeletal structures and proportions. For example, the process begins with a comprehensive analysis of the target avatar's skeletal structure, where the system examines the proportions, joint hierarchy, and relative bone lengths of the destination character model (e.g., the 3D avatar 520). This analysis creates a detailed skeletal mapping between the source animation skeleton (generated by the diffusion model) and the target avatar skeleton, identifying corresponding joints and calculating scaling factors needed for proper adaptation.

Once the skeletal mapping is established, the system applies a series of mathematical transformations to adjust the animation data to accommodate the target character's unique proportions. This involves recalculating joint rotations and positions using forward and inverse kinematics equations to maintain the animation's intended motion while adapting to different limb lengths and body shapes. For example, if the target avatar has longer arms than the source skeleton, the system can mathematically adjust the arm rotations to ensure that hand positions remain appropriate relative to the body and environment. The retargeting process then applies specialized joint transforms that preserve the animation's artistic intent while ensuring physical plausibility on the new skeleton. This includes maintaining proper ground contact for feet, appropriate reach distances for hands, and natural joint limits specific to the target avatar's anatomy. The system employs quaternion-based rotation adjustments and position offsets to ensure smooth transitions between poses while respecting the biomechanical constraints of the target skeleton. These transforms are calculated frame-by-frame throughout the animation sequence to maintain temporal coherence.

An aspect of the animation retargeting process is the detection and prevention of body part interpenetration, which becomes particularly challenging when adapting animations to different body shapes. The system implements collision detection algorithms that identify potential intersections between body parts, such as arms penetrating the torso or legs crossing unnaturally. When such interpenetrations are detected, the system applies corrective transformations to the affected joints, subtly adjusting rotations and positions to eliminate the interpenetration while minimizing deviation from the original animation. This correction process iteratively refines joint positions until all interpenetrations are resolved, ensuring the final animation maintains both visual quality and physical plausibility when applied to various 3D avatar models with different skeletal structures and body proportions. Namely, the post-processing component 522 can be responsible for detecting and preventing body part interpenetration in the final animation sequence, which helps maintain the physical plausibility of the generated motions.

After post-processing, the refined animation data is applied to a 3D avatar 520. This avatar rendering demonstrates how the generated animation appears when applied to a 3D character model such as a Bitmoji or BodyMorph avatar. In social media applications, the animation data enables personalized avatars to perform expressive movements in messaging platforms, allowing users to communicate emotions and actions through their digital representations rather than static images, significantly enhancing user engagement and interaction. Within augmented reality experiences or other digital effect applications, the animation data drives 3D avatars in digital effect creations, where animated characters can interact with real-world environments, respond to user movements, or perform choreographed sequences that blend seamlessly with physical surroundings, creating immersive and interactive experiences.

For virtual reality applications, the animation data provides realistic movement for avatars in social VR spaces, enabling natural-looking interactions between users in shared virtual environments and allowing for more convincing embodiment in virtual worlds through fluid, human-like motion patterns. In storytelling and film applications, the animation data can be sequenced to create narrative content like Bitmoji Stories, where characters perform complex emotional sequences that convey plot elements without requiring manual keyframing of each movement, dramatically reducing production time while maintaining high-quality character animation.

For video game integration, the animation data enables responsive character movements that adapt to player inputs or game events, allowing game developers to implement a wide range of character animations without the extensive manual work traditionally required, while maintaining consistent character identity across different motion types. Additionally, the animation data can be exported in industry-standard formats like FBX or GLB files, making it compatible with professional animation software such as Maya, Blender, or other 3D creation tools, allowing for further refinement or integration into larger production pipelines.

The entire pipeline, shown in FIG. 5, transforms a simple text prompt into a detailed, high-quality animation sequence that can be directly applied to 3D avatars, significantly reducing the time and effort required compared to traditional animation methods. This system leverages advanced machine learning techniques to automate the creation of animations that would otherwise require extensive manual effort by skilled professionals. The architecture shown in FIG. 5 represents a significant technical improvement over conventional approaches by implementing a VAE that compresses motion data along the temporal axis, optimizing the conditioning of motion generation on text embeddings, and applying sophisticated post-processing techniques to enhance the quality and realism of the generated animations.

Through the combination of LLM-based prompt expansion, diffusion-based motion generation, and sophisticated post-processing, the animation generation system 504 represents a comprehensive solution to the challenge of creating high-quality animations from simple text descriptions.

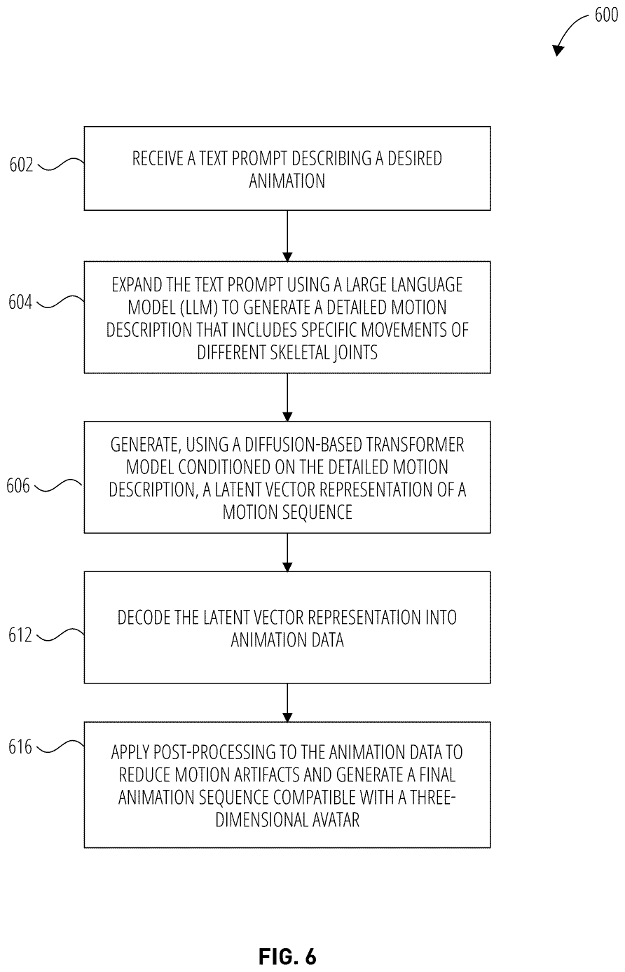

FIG. 6 is a flowchart illustrating routine 600 (e.g., a method or process), according to some examples. Although the example method depicted in FIG. 6 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 602, the animation generation system 504 receives a text prompt describing a desired animation. This text prompt serves as the initial input from a user who wants to generate an animation, and can be a concise description such as “a person is playing golf” or “a person walks like a zombie.”

In operation 604, the animation generation system 504 expands the text prompt using the LLM 508 to generate a detailed motion description that includes specific movements of different skeletal joints. This expansion process transforms the concise user input into a comprehensive description that breaks down the animation into specific body postures, limb movements, and motion characteristics not explicitly mentioned in the original prompt.

In operation 606, the animation generation system 504 generates, using a diffusion-based transformer model 514 conditioned on the detailed motion description, a latent vector representation of a motion sequence. The diffusion-based transformer model 514 includes cross-attention mechanisms to condition the generation process on text embeddings, ensuring accurate alignment between the textual description and the resulting motion.

In operation 612, the animation generation system 504 decodes the latent vector representation into animation data. This decoding process typically uses a VAE component 516 decoder that was jointly trained with the diffusion-based transformer model 514, allowing for better latent space alignment and more accurate reconstruction of the motion sequence.

In operation 616, the animation generation system 504 applies post-processing to the animation data to reduce motion artifacts and generate a final animation sequence compatible with a three-dimensional avatar. This post-processing includes techniques such as foot inverse kinematics to correct foot placement issues, predicting global root movements in the XZ plane to reduce foot skating issues, animation retargeting to accommodate different character body proportions and shapes, and detecting and preventing body part interpenetration in the final animation sequence.

FIG. 7 is a flowchart illustrating routine 702 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

FIG. 7 is a flowchart illustrating routine 702 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 704, the animation generation system 504 receives a user prompt. This is the initial step where the system accepts a text input from a user describing the desired animation, such as “a person is playing golf” or “a person walks like a zombie.”

In operation 706, the animation generation system 504 rewrites the user prompt using an LLM 508. This expansion process transforms the concise user input into a comprehensive description that includes specific movements of different skeletal joints, providing detailed motion characteristics not explicitly mentioned in the original prompt.

In operation 708, the animation generation system 504 extracts text embeddings from the rewritten user prompt. The system uses a text encoder 510 (such as T5) to produce an embedding sequence that preserves temporal semantics, unlike conventional approaches that use CLIP which outputs a single vector without temporal information.

In operation 710, the animation generation system 504 generates raw animation data including motion feature representations. This is accomplished using a diffusion-based transformer model 514 conditioned on the text embeddings, which creates a latent vector representation that is then decoded into animation data.

In operation 712, the animation generation system 504 processes the animation data to correct foot inverse kinematics. This step resolves artifacts such as foot penetration into the ground, crossing or interpenetration of legs during movement, and ensures physical plausibility of the animation.

In operation 714, the animation generation system 504 predicts root global movement in the XZ plane. This step is particularly important for ensuring accurate foot placement and preventing foot skating issues in the animation data.

In operation 716, the animation generation system 504 retargets the animation data based on body shapes. This process ensures that animations remain visually accurate and physically consistent when applied to different character rigs and body shapes, preventing issues like arm penetration into the torso or other body parts.

In operation 718, the animation generation system 504 applies predefined facial expression using an expression label generated by the LLM 508. This enhances realism by ensuring that facial movements match the intended emotion conveyed by the prompt.

In operation 720, the animation generation system 504 animates a 3D avatar using the animation data and the predefined facial expression. This final step applies all the processed animation data to a three-dimensional avatar, creating the complete animation sequence as requested by the user.

### SYSTEM WITH HEAD-WEARABLE APPARATUS

FIG. 8 illustrates a system 800 including a head-wearable apparatus 116 with a selector input device, according to some examples. FIG. 8 is a high-level functional block diagram of an example head-wearable apparatus 116 communicatively coupled to a mobile device 114 and various server systems 804 (e.g., the server system 110 of FIG. 1) via various networks (network 816 or network 108 of FIG. 1.

The head-wearable apparatus 116 includes one or more cameras, each of which may be, for example, a visible light camera 806, an infrared emitter 808, and an infrared camera 810.

The mobile device 114 connects with head-wearable apparatus 116 using both a low-power wireless connection 812 and a high-speed wireless connection 814. The mobile device 114 is also connected to the server system 804 and the network 816.

The head-wearable apparatus 116 further includes two image displays of the image display of optical assembly 818. The two image displays of optical assembly 818 include one associated with the left lateral side and one associated with the right lateral side of the head-wearable apparatus 116. The head-wearable apparatus 116 also includes an image display driver 820, an image processor 822, low-power circuitry 824, and high-speed circuitry 826. The image display of optical assembly 818 is for presenting images and videos, including an image that can include a graphical user interface to a user of the head-wearable apparatus 116.

The image display driver 820 commands and controls the image display of optical assembly 818. The image display driver 820 may deliver image data directly to the image display of optical assembly 818 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 828 (e.g., touch sensor or push button), including an input surface on the head-wearable apparatus 116. The user input device 828 (e.g., touch sensor or push button) is to receive from the user an input selection to manipulate the graphical user interface of the presented image.

The components shown in FIG. 8 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 806 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 802, which stores instructions to perform a subset, or all the functions described herein. The memory 802 can also include storage device.

As shown in FIG. 8, the high-speed circuitry 826 includes a high-speed processor 830, a memory 802, and high-speed wireless circuitry 832. In some examples, the image display driver 820 is coupled to the high-speed circuitry 826 and operated by the high-speed processor 830 to drive the left and right image displays of the image display of optical assembly 818. The high-speed processor 830 may be any processor capable of managing high-speed communications and operation of any general computing system needed for the head-wearable apparatus 116. The high-speed processor 830 includes processing resources needed for managing high-speed data transfers on a high-speed wireless connection 814 to a wireless local area network (WLAN) using the high-speed wireless circuitry 832. In certain examples, the high-speed processor 830 executes an operating system such as a LINUX operating system or other such operating system of the head-wearable apparatus 116, and the operating system is stored in the memory 802 for execution. In addition to any other responsibilities, the high-speed processor 830 executing a software architecture for the head-wearable apparatus 116 is used to manage data transfers with high-speed wireless circuitry 832. In certain examples, the high-speed wireless circuitry 832 is configured to implement Institute of Electrical and Electronic Engineers (IEEE) 802.11 communication standards, also referred to herein as WI-FI®. In some examples, other high-speed communications standards may be implemented by the high-speed wireless circuitry 832.

The low-power wireless circuitry 834 and the high-speed wireless circuitry 832 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 812 and the high-speed wireless connection 814, may be implemented using details of the architecture of the head-wearable apparatus 116, as can other elements of the Network 816.

The memory 802 includes any storage device capable of storing various data and applications, including, among other things, camera data generated by the left and right visible light cameras 806, the infrared camera 810, and the image processor 822, as well as images generated for display by the image display driver 820 on the image displays of the image display of optical assembly 818. While the memory 802 is shown as integrated with high-speed circuitry 826, in some examples, the memory 802 may be an independent standalone element of the head-wearable apparatus 116. In certain such examples, electrical routing lines may provide a connection through a chip that includes the high-speed processor 830 from the image processor 822 or the low-power processor 836 to the memory 802. In some examples, the high-speed processor 830 may manage addressing of the memory 802 such that the low-power processor 836 will boot the high-speed processor 830 any time that a read or write operation involving memory 802 is needed.

As shown in FIG. 8, the low-power processor 836 or high-speed processor 830 of the head-wearable apparatus 116 can be coupled to the camera (visible light camera 806, infrared emitter 808, or infrared camera 810), the image display driver 820, the user input device 828 (e.g., touch sensor or push button), and the memory 802.

The head-wearable apparatus 116 is connected to a host computer. For example, the head-wearable apparatus 116 is paired with the mobile device 114 via the high-speed wireless connection 814 or connected to the server system 804 via the Network 816. The server system 804 may be one or more computing devices as part of a service or network computing system, for example, that includes a processor, a memory, and network communication interface to communicate over the Network 816 with the mobile device 114 and the head-wearable apparatus 116.

The mobile device 114 includes a processor and a network communication interface coupled to the processor. The Network communication interface allows for communication over the Network 816, low-power wireless connection 812, or high-speed wireless connection 814. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 820. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 804, such as the user input device 828, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 812 and high-speed wireless connection 814 from the mobile device 114 via the low-power wireless circuitry 834 or high-speed wireless circuitry 832.

### MACHINE ARCHITECTURE

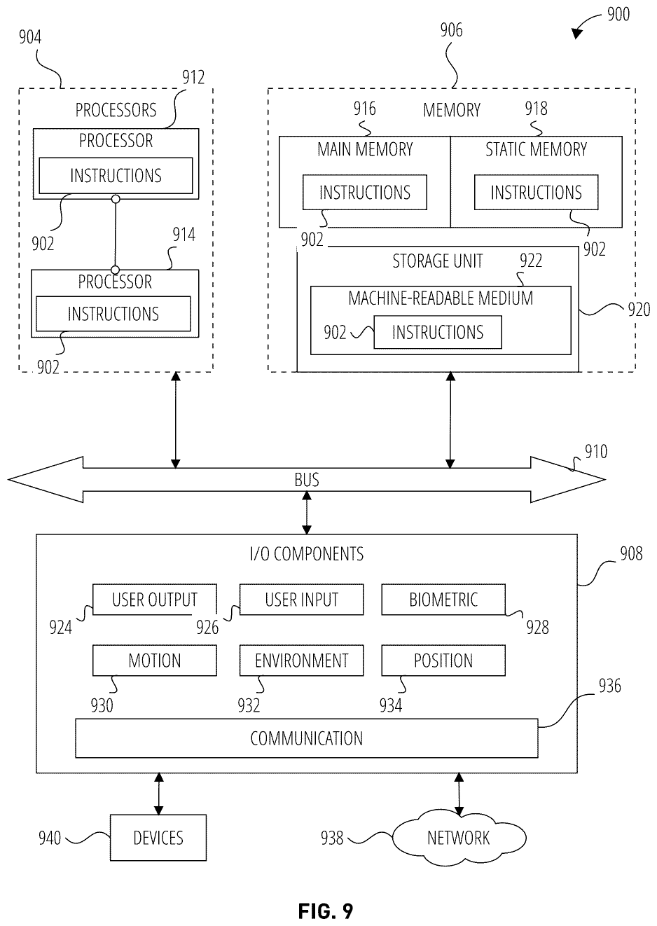

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the server system 110. In some examples, the machine 900 may also comprise both client and server systems, with certain operations of a particular method or algorithm being performed on the server-side and with certain operations of the method or algorithm being performed on the client-side.

The machine 900 may include processors 904, memory 906, and input/output I/O components 908, which may be configured to communicate with each other via a bus 910.

The memory 906 includes a main memory 916, a static memory 918, and a storage unit 920, both accessible to the processors 904 (e.g., processor 912 or processor 914 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 908 further include communication components 936 operable to couple the machine 900 to a Network 938 or devices 940 via respective coupling or connections. For example, the communication components 936 may include a network interface component or another suitable device to interface with the Network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph^{TM}, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### SOFTWARE ARCHITECTURE

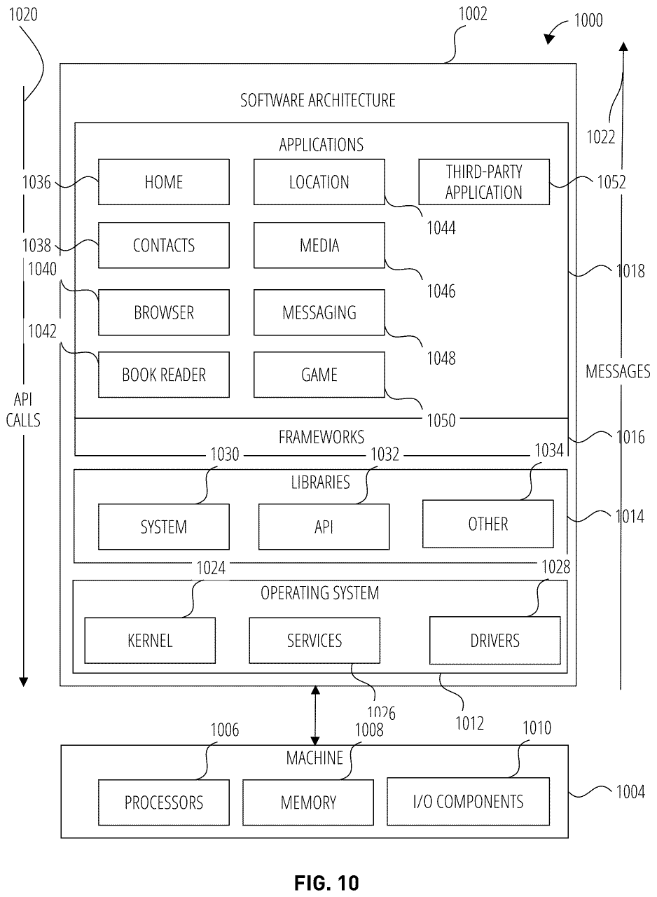

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: receiving a text prompt describing a desired animation; expanding the text prompt using a large language model (LLM) to generate a detailed motion description that includes specific movements of different skeletal joints; generating, using a diffusion-based transformer model conditioned on the detailed motion description, a latent vector representation of a motion sequence; decoding the latent vector representation into animation data; and applying post-processing to the animation data to reduce motion artifacts and generate a final animation sequence compatible with a three-dimensional avatar.

Example 2. The system of Example 1, wherein the latent vector representation is decoded using a variational autoencoder (VAE) decoder.

Example 3. The system of any one of Examples 1-2, wherein expanding the text prompt comprises using the LLM to infer detailed body posture, limb movement, and motion characteristics not explicitly mentioned in the text prompt.

Example 4. The system of any one of Examples 1-3, wherein the detailed motion description includes a temporal sequence of movements, and wherein the operations further comprise: encoding the detailed motion description using a text encoder to produce a text embedding sequence that preserves temporal semantics, the diffusion-based transformer model being conditioned on the text embedding.

Example 5. The system of Example 4, wherein the text encoder comprises a T5 model that outputs a sequence of vectors rather than a single vector, and wherein the sequence of vectors has a length of at least 120 tokens with a dimension of at least 4096.

Example 6. The system of any one of Examples 1-5, wherein the diffusion-based transformer model includes cross-attention mechanisms to condition the generating the latent vector representation on text embeddings, and wherein the diffusion-based transformer model comprises multiple transformer layers, each having multiple attention heads.

Example 7. The system of any one of Examples 1-6, wherein decoding the latent vector representation comprises using a variational autoencoder (VAE) decoder that was jointly trained with the diffusion-based transformer model, and wherein the latent vector representation compresses the motion sequence along a temporal axis.

Example 8. The system of any one of Examples 1-7, wherein applying post-processing comprises applying foot inverse kinematics to correct foot placement issues and predicting global root movements in an XZ plane to reduce foot skating issues in the animation data.

Example 9. The system of any one of Examples 1-8, wherein applying post-processing comprises animation retargeting to accommodate different character body proportions and shapes, and detecting and preventing body part interpenetration in the final animation sequence.

Example 10. The system of Example 9, wherein applying post-processing comprises: analyzing an avatar body proportions and shape; adjusting the animation data to accommodate the avatar body proportions and shape; applying joint transforms to make the animation compatible with the avatar body proportions and shape; identifying instances where body parts intersect or penetrate each other in the animation data; applying corrective transformations to affected joints; adjusting joint rotations and positions to eliminate interpenetration; and maintaining motion quality while ensuring physical consistency in the animation data.

Example 11. The system of any one of Examples 1-10, wherein the operations further comprise: extracting a facial expression label from the detailed motion description; applying the facial expression to the final animation sequence.

Example 12. The system of Example 11, wherein the operations further comprise: searching a database of facial expressions based on the extracted facial expression label; retrieving an individual facial expression from the database corresponding to the extracted facial expression label; and applying the individual facial expression to the three-dimensional avatar.

Example 13. The system of any one of Examples 1-12, wherein the operations further comprise: training the diffusion-based transformer model using a training dataset comprising motion capture data annotated with detailed textual descriptions; processing an individual detailed textual description by the diffusion-based transformer model to generate a predicted latent vector; computing a deviation between the predicted latent vector generated by the diffusion-based transformer model and a ground truth latent vector derived from the motion capture data corresponding to the individual detailed textual description; comparing the computed deviation with a threshold value to determine model accuracy; and updating parameters of the diffusion-based transformer model based on the comparing to minimize the deviation.

Example 14. The system of Example 13, wherein the operations comprise: processing the latent vector by multiple machine learning models to generate the animation data, the multiple machine learning models being trained using multiple loss functions; computing a flow velocity loss by comparing predicted velocity vectors with ground truth velocity vectors; computing a feature loss by comparing decoded latent representations with ground truth motion features; computing a joint position loss by applying forward kinematics to obtain joint positions and comparing with ground truth positions; computing a foot skating loss and a smoothness loss by analyzing motion continuity and physical plausibility; aggregating the multiple loss functions to determine a total loss value; and updating parameters of the diffusion-based transformer model and the multiple machine learning models based on the total loss value.

Example 15. The system of any one of Examples 1-14, wherein the operations further comprise: training a variational autoencoder (VAE) using motion capture data by: compressing human motion sequences into latent vector representations using a VAE encoder; reconstructing the human motion sequences from the latent vector representations using a VAE decoder; computing a reconstruction loss between original human motion sequences and the reconstructed human motion sequences; comparing the reconstruction loss with a threshold value to determine encoding-decoding accuracy; and updating parameters of the VAE encoder and the VAE decoder based on the comparing to minimize the reconstruction loss and improve compression of motion features along a temporal axis.

Example 16. The system of any one of Examples 1-15, wherein the operations further comprise: training a root motion prediction network using motion capture data by: masking out root XZ velocities in input motion features; processing the masked motion features by the root motion prediction network to predict root XZ velocities; computing a deviation between the predicted root XZ velocities and ground truth root XZ velocities from the motion capture data; comparing the computed deviation with a threshold value to determine prediction accuracy; and updating parameters of the root motion prediction network based on the comparing to minimize the deviation and reduce foot skating issues in the final animation sequence.

Example 17. The system of any one of Examples 1-16, wherein the operations further comprise rendering the final animation sequence on the three-dimensional avatar.

Example 18. The system of any one of Examples 1-17, wherein the operations further comprise using the final animation sequence in a digital effect comprising an augmented reality experience.

Example 19. A computer-implemented method comprising: receiving a text prompt describing a desired animation; expanding the text prompt using a large language model (LLM) to generate a detailed motion description that includes specific movements of different skeletal joints; generating, using a diffusion-based transformer model conditioned on the detailed motion description, a latent vector representation of a motion sequence; decoding the latent vector representation into animation data; and applying post-processing to the animation data to reduce motion artifacts and generate a final animation sequence compatible with a three-dimensional avatar.

Example 20. A non-transitory computer-readable storage medium storing instructions that, when executed by at least one processor, cause the at least one processor to perform operations comprising: receiving a text prompt describing a desired animation; expanding the text prompt using a large language model (LLM) to generate a detailed motion description that includes specific movements of different skeletal joints; generating, using a diffusion-based transformer model conditioned on the detailed motion description, a latent vector representation of a motion sequence; decoding the latent vector representation into animation data; and applying post-processing to the animation data to reduce motion artifacts and generate a final animation sequence compatible with a three-dimensional avatar.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.” “Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
receiving a text prompt describing a desired animation;
expanding the text prompt using a large language model (LLM) to generate a detailed motion description that includes specific movements of different skeletal joints;
generating, using a diffusion-based transformer model conditioned on the detailed motion description, a latent vector representation of a motion sequence;
decoding the latent vector representation into animation data; and
applying post-processing to the animation data to reduce motion artifacts and generate a final animation sequence compatible with a three-dimensional avatar.

2. The system of claim 1, wherein the latent vector representation is decoded using a variational autoencoder (VAE) decoder.

3. The system of claim 1, wherein expanding the text prompt comprises using the LLM to infer detailed body posture, limb movement, and motion characteristics not explicitly mentioned in the text prompt.

4. The system of claim 1, wherein the detailed motion description includes a temporal sequence of movements, and wherein the operations further comprise:
encoding the detailed motion description using a text encoder to produce a text embedding sequence that preserves temporal semantics, the diffusion-based transformer model being conditioned on the text embedding sequence.

5. The system of claim 4, wherein the text encoder comprises a T5 model that outputs a sequence of vectors rather than a single vector, and wherein the sequence of vectors has a length of at least 120 tokens with a dimension of at least 4096.

6. The system of claim 1, wherein the diffusion-based transformer model includes cross-attention mechanisms to condition the generating of the latent vector representation on text embeddings, and wherein the diffusion-based transformer model comprises multiple transformer layers, each having multiple attention heads.

7. The system of claim 1, wherein decoding the latent vector representation comprises using a variational autoencoder (VAE) decoder that was jointly trained with the diffusion-based transformer model, and wherein the latent vector representation compresses the motion sequence along a temporal axis.

8. The system of claim 1, wherein applying post-processing comprises applying foot inverse kinematics to correct foot placement issues and predicting global root movements in an XZ plane to reduce foot skating issues in the animation data.

9. The system of claim 1, wherein applying post-processing comprises animation retargeting to accommodate different character body proportions and shapes, and detecting and preventing body part interpenetration in the final animation sequence.

10. The system of claim 9, wherein applying post-processing comprises:
analyzing an avatar body proportions and shape;
adjusting the animation data to accommodate the avatar body proportions and shape;
applying joint transforms to make the animation data compatible with the avatar body proportions and shape;
identifying instances where body parts intersect or penetrate each other in the animation data;
applying corrective transformations to affected joints;
adjusting joint rotations and positions to eliminate interpenetration; and
maintaining motion quality while ensuring physical consistency in the animation data.

11. The system of claim 1, wherein the operations further comprise:
extracting a facial expression label from the detailed motion description; and
applying a facial expression corresponding to the facial expression label to the final animation sequence.

12. The system of claim 11, wherein the operations further comprise:
searching a database of facial expressions based on the extracted facial expression label;
retrieving an individual facial expression from the database corresponding to the extracted facial expression label; and
applying the individual facial expression to the three-dimensional avatar.

13. The system of claim 1, wherein the operations further comprise:
training the diffusion-based transformer model using a training dataset comprising motion capture data annotated with detailed textual descriptions;
processing an individual detailed textual description by the diffusion-based transformer model to generate a predicted latent vector;
computing a deviation between the predicted latent vector generated by the diffusion-based transformer model and a ground truth latent vector derived from the motion capture data corresponding to the individual detailed textual description;
comparing the computed deviation with a threshold value to determine model accuracy; and
updating parameters of the diffusion-based transformer model based on the comparing to minimize the deviation.

14. The system of claim 13, wherein the operations comprise:
processing the predicted latent vector by multiple machine learning models to generate the animation data, the multiple machine learning models being trained using multiple loss functions;
computing a flow velocity loss by comparing predicted velocity vectors with ground truth velocity vectors;
computing a feature loss by comparing decoded latent representations with ground truth motion features;
computing a joint position loss by applying forward kinematics to obtain joint positions and comparing with ground truth positions;
computing a foot skating loss and a smoothness loss by analyzing motion continuity and physical plausibility;
aggregating the multiple loss functions to determine a total loss value; and
updating parameters of the diffusion-based transformer model and the multiple machine learning models based on the total loss value.

15. The system of claim 1, wherein the operations further comprise:
training a variational autoencoder (VAE) using motion capture data by:
compressing human motion sequences into latent vector representations using a VAE encoder;
reconstructing the human motion sequences from the latent vector representations using a VAE decoder;
computing a reconstruction loss between original human motion sequences and the reconstructed human motion sequences;
comparing the reconstruction loss with a threshold value to determine encoding-decoding accuracy; and
updating parameters of the VAE encoder and the VAE decoder based on the comparing to minimize the reconstruction loss and improve compression of motion features along a temporal axis.

16. The system of claim 1, wherein the operations further comprise:
training a root motion prediction network using motion capture data by:
masking out root XZ velocities in input motion features;
processing the masked motion features by the root motion prediction network to predict root XZ velocities;
computing a deviation between the predicted root XZ velocities and ground truth root XZ velocities from the motion capture data;
comparing the computed deviation with a threshold value to determine prediction accuracy; and
updating parameters of the root motion prediction network based on the comparing to minimize the deviation and reduce foot skating issues in the final animation sequence.

17. The system of claim 1, wherein the operations further comprise rendering the final animation sequence on the three-dimensional avatar.

18. The system of claim 1, wherein the operations further comprise using the final animation sequence in a digital effect comprising an augmented reality experience.

19. A computer-implemented method comprising:
receiving a text prompt describing a desired animation;
expanding the text prompt using a large language model (LLM) to generate a detailed motion description that includes specific movements of different skeletal joints;
generating, using a diffusion-based transformer model conditioned on the detailed motion description, a latent vector representation of a motion sequence;
decoding the latent vector representation into animation data; and
applying post-processing to the animation data to reduce motion artifacts and generate a final animation sequence compatible with a three-dimensional avatar.

20. A non-transitory computer-readable storage medium storing instructions that, when executed by at least one processor, cause the at least one processor to perform operations comprising:
receiving a text prompt describing a desired animation;
expanding the text prompt using a large language model (LLM) to generate a detailed motion description that includes specific movements of different skeletal joints;
generating, using a diffusion-based transformer model conditioned on the detailed motion description, a latent vector representation of a motion sequence;
decoding the latent vector representation into animation data; and
applying post-processing to the animation data to reduce motion artifacts and generate a final animation sequence compatible with a three-dimensional avatar.
